(19) United States
(12) Patent Application Publication
(10) Pub. No.: US 2017/0284530 A1
(43) Pub. Date: Oct. 5, 2017

(54) SPROCKET STRUCTURE OF ENGINE

(71) Applicants: HYUNDAI MOTOR COMPANY, Seoul (KR); KIA MOTORS CORPORATION, Seoul (KR)

(72) Inventors: Jae Kyun Lee, Seoul (KR); Jae Kyu Lee, Hwaseong-si (KR)

(73) Assignees: HYUNDAI MOTOR COMPANY, Seoul (KR); KIA MOTORS CORPORATION, Seoul (KR)

(21) Appl. No.: 15/285,220

(22) Filed: Oct. 4, 2016

(30) Foreign Application Priority Data
Mar. 29, 2016 (KR) 10-2016-0037312

(51) Int. Cl. F16H 55/12; F16H 55/17; F16H 7/02; F01L 1/02; F02B 67/06

(52) U.S. Cl. CPC F16H 55/12; F01L 1/024; F02B 67/06; F16H 7/023; F16H 55/171

(57) ABSTRACT

The present disclosure provides a sprocket structure of an engine including a crank sprocket provided in a cylinder block of an engine and driven by a crank shaft, a high pressure pump sprocket configured to receive rotational force from the crank sprocket through a timing belt, and a cam sprocket having an interior installed on a camshaft and an exterior rotatably coupled to the timing belt so as to be driven. Since a tensioner is fixed in a state in which tension is applied to the timing belt through jigs of the crank sprocket and the high pressure pump sprocket and the cam sprocket having a dual-structure, loss of tension is reduced, thus minimizing occurrence of an error of the timing belt to enhance quality of a product.

### CROSS-REFERENCE TO RELATED APPLICATION

This application claims priority to and the benefit of Korean Patent Application No. 10-2016-0037312, filed on Mar. 29, 2016, the entire contents of which is incorporated herein in its entirety by reference.

### FIELD

The present disclosure relates to a sprocket structure of an engine, and more particularly, to a sprocket structure of an engine for improving engine performance by minimizing occurrence of an error of a timing belt.

### BACKGROUND

The statements in this section merely provide background information related to the present disclosure and may not constitute prior art.

In general, a cam in a vehicle engine is used to control an opening and closing time of an intake valve and an exhaust valve.

A camshaft is a shaft to which cams are integrally fastened. In some instances, the camshaft has a driving gear of a power distributor and an oil pump and an eccentric cam for driving a fuel supply pump, and is supposed to adjust valve timing such that valves may vertically reciprocate at an accurate time in a determined order and may be dosed by a valve spring.

In a related art valve timing adjusting device, a crank sprocket driven by a crank shaft is installed on one side of a cylinder block constituting an engine, rotational force of the crank sprocket is transmitted to an oil pump sprocket, an intake cam sprocket, and an exhaust cam sprocket through a timing belt, and a tensioner adjusting tension of the timing belt is installed in the cylinder block.

In the related art valve timing adjusting device, a belt is assembled by adjusting timing of the crank sprocket and the cam sprocket to correspond to each other, the tensioner is fixed and corrected in position, and thereafter, an engine is rotated to make tension of the timing belt uniform.

However, we have found that in the related art, when pumps are simultaneously driven, a length of the timing belt is increased to cause a timing error of up to about 3 degrees due to a position and tolerance, thereby degrading engine performance.

Further areas of applicability will become apparent from the description provided herein. It should be understood that the description and specific examples are intended for purposes of illustration only and are not intended to limit the scope of the present disclosure.

### SUMMARY

The present disclosure provides a sprocket structure of an engine capable of enhancing engine performance by minimizing occurrence of an error in a timing belt.

According to one form of the present disclosure, a sprocket structure of an engine includes: a crank sprocket provided in a cylinder block of an engine and driven by a crank shaft; a high pressure pump sprocket configured to receive rotational force from the crank sprocket through a timing belt; and a cam sprocket having an inner sprocket installed on a camshaft and an outer sprocket rotatably coupled to the timing belt so as to be driven.

The cam sprocket may include: the outer sprocket formed on an outer side of the cam sprocket and provided to be freely rotated by the timing belt; and the inner sprocket provided on an inner side of the outer sprocket and directly connected to the camshaft to fix timing, wherein the cam sprocket applies tension to the timing belt.

The crank sprocket may include a crank jig inserted into the center thereof to fix a position of the crank sprocket with respect to the crank shaft, and configured to rotate the crank sprocket.

The high pressure pump sprocket may include a high pressure pump jig inserted into the center thereof to fix a position of the high pressure pump sprocket with respect to a shaft of a high pressure pump, and configured to rotate the high pressure pump sprocket.

The inner sprocket may be fastened to the outer sprocket by a bolt or a plurality of bolts or similar fasteners.

A plurality of fastening portions may be formed on an inner circumferential surface of the outer sprocket to which the inner sprocket may be fastened and fixed by the bolt.

A coupling hole may be formed at the center of the inner sprocket to allow the camshaft to be fixed and coupled thereto.

A plurality of tensioners fixing tension may be provided on an outer side of the timing belt.

According to another form of the present disclosure, a sprocket structure of an engine includes: a crank sprocket provided in a cylinder block of an engine, driven by a crankshaft, to the crank sprocket having a crank jig inserted into the center thereof to fix the crankshaft and allow only an outer portion to be rotated; a high pressure pump sprocket configured to receive rotational force from the crank sprocket through a timing belt, the high pressure pump sprocket having a high pressure pump jig inserted into the center thereof to fix a shaft of a high pressure pump and allow only an outer portion to be rotated; and a cam sprocket having an outer sprocket formed on an outer side of the cam sprocket and that is freely rotated by the timing belt and an inner sprocket provided within the outer sprocket and directly connected to a camshaft to fix timing, and to apply tension to the timing belt.

A plurality of fastening portions may be formed on an inner circumferential surface of the outer sprocket to which the inner sprocket may be fastened and fixed by a bolt, and a coupling hole may be formed at the center of the inner sprocket to which the camshaft may be fixed and coupled.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a view illustrating a sprocket structure of an engine according to one form of the present disclosure;

FIG. 2 is a view illustrating a high pressure pump sprocket in a sprocket structure of an engine according to one form of the present disclosure;

FIG. 3 is a view illustrating a crank sprocket in a sprocket structure of an engine according to one form of the present disclosure;

FIG. 4 is a view illustrating a cam sprocket in a sprocket structure of an engine according to one form of the present disclosure; and

FIG. 5 is a view illustrating an outer sprocket and an inner sprocket of a cam sprocket in a sprocket structure of an engine according to one form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

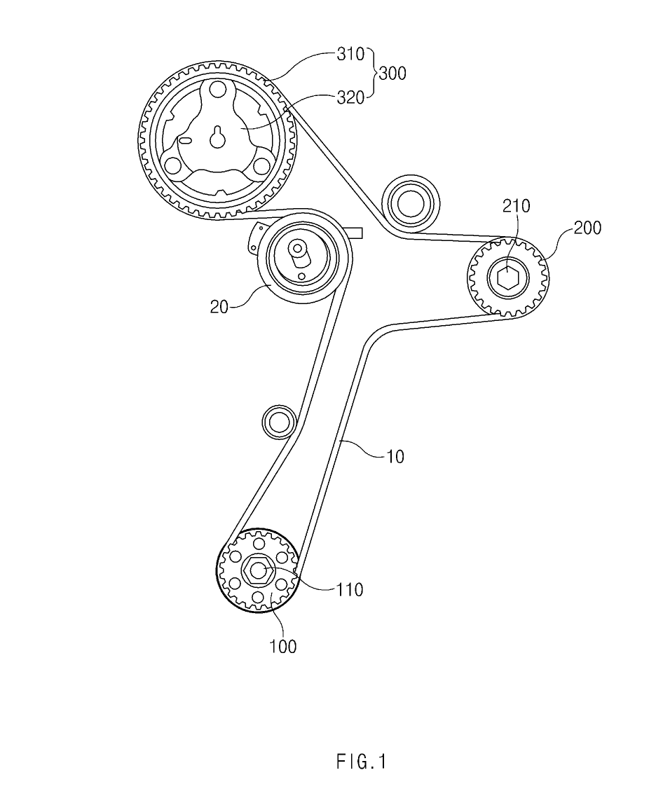

As illustrated in FIGS. 1 through 5, a sprocket structure of an engine according to various forms of the present disclosure includes a crank sprocket 100 provided in a crank shaft 110, a high pressure pump sprocket 200 connected to the crank sprocket 100 through a timing belt 10, and a cam sprocket 300 coupled to the timing belt 10.

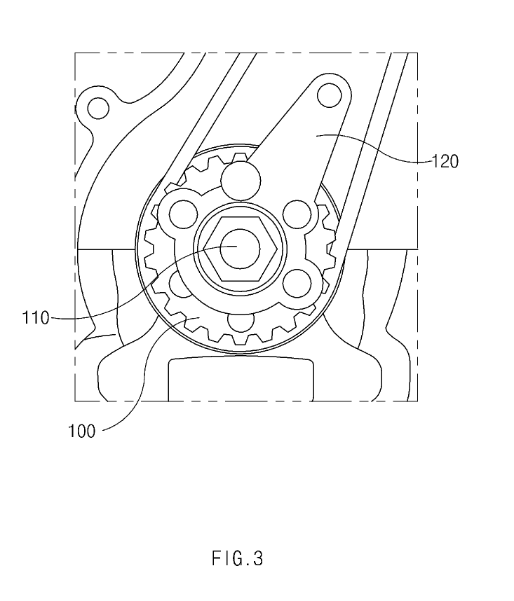

As illustrated in FIGS. 1 and 3, the crank sprocket 100 is provided in a cylinder block of an engine and driven by the crank shaft 110.

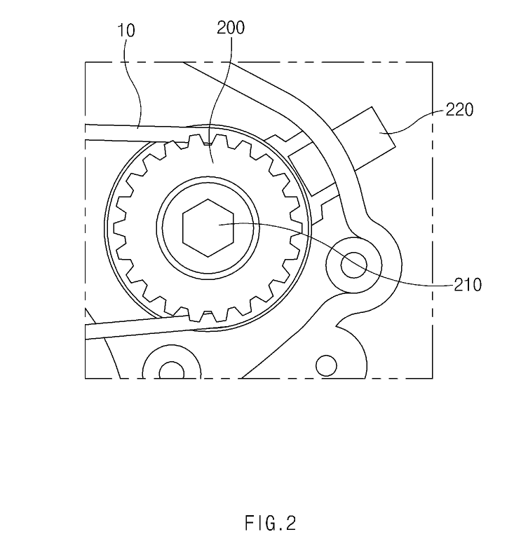

As illustrated in FIGS. 1 and 2, the high pressure pump sprocket 200, rotated by a high pressure pump, is connected to the crank sprocket 100 through the timing belt 10 to receive rotational force from the crank sprocket 100.

The cam sprocket 300 is connected to the crank sprocket 100 and the high pressure pump sprocket 200 through the timing belt 10.

Here, an interior of the cam sprocket 300 is installed in a camshaft (not shown), and an exterior thereof has a two-piece structure to be rotatably coupled to the timing belt 10.

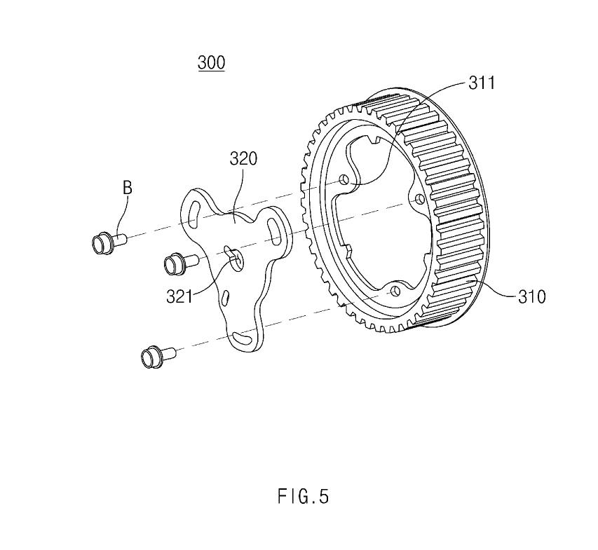

As illustrated in FIGS. 1 and 5, the cam sprocket 300, applying tension to the timing belt 10, includes an outer sprocket 310 and an inner sprocket 320.

The outer sprocket 310 is provided on an outer side and freely rotated by the timing belt 10.

The inner sprocket 320 is provided on an inner side of the outer sprocket 310 and directly connected to the camshaft to fix timing.

Here, the crank sprocket 100 has a crank jig 120 inserted into the center thereof, and in a state in which a position of the crank sprocket 100 is fixed by the crank jig 120, the crank sprocket 100 may be rotated.

The high pressure pump sprocket 200 has a high pressure pump jig 220 inserted into the center thereof, and in a state in which a position of the high pressure pump sprocket 200 is fixed by the high pressure pump jig 220, the high pressure pump sprocket 200 may be rotated.

The inner sprocket 320 of the cam sprocket 300 is fastened to the outer sprocket 310 through a bolt B to enhance coupling force.

A plurality of fastening portions 311 may be formed on an inner circumferential surface of the outer sprocket 310 to allow the inner sprocket 320 to be fastened and fixed by the bolt B.

A coupling hole 321 is formed at the center of the inner sprocket 320 to allow a camshaft to be fixed and coupled thereto.

A plurality of tensioners 20 fixing tension are provided on an outer side of the timing belt 10.

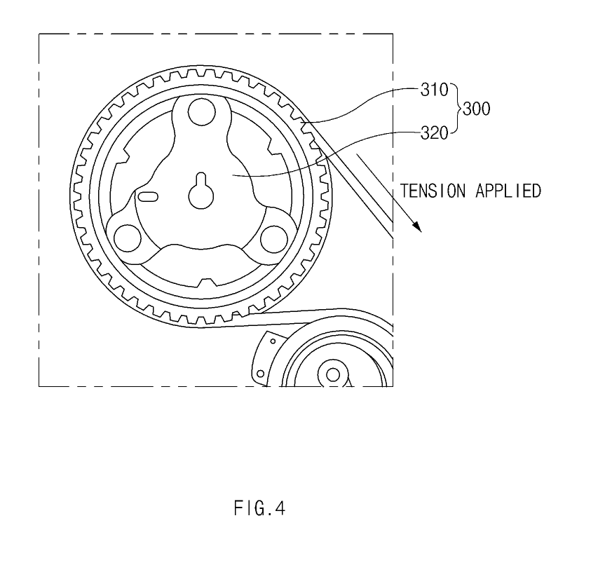

That is, as illustrated in FIGS. 1 and 5, in a state in which the crank sprocket 100 and the high pressure pump sprocket 200 are fixed through the crank jig 120 and the high pressure pump jig 220, the inner sprocket 320 provided within the cam sprocket 300 to the camshaft and the timing belt 10 is assembled. Here, as illustrated in FIG. 4, the inner sprocket 320 and the outer sprocket 310 of the cam sprocket 300 are temporarily fastened through the bolt B, and in this state, the outer sprocket 310 is rotated in a counterclockwise direction such that only the outer sprocket 310 is rotated with the inner sprocket 320 fixed, to apply tension to the timing belt 10, and thereafter, the outer sprocket 310 and the inner sprocket 320 are fastened through the bolt B and the tensioner 20 is fixed.

As a result, by employing the cam sprocket 300 having the two-piece structure in which the inner sprocket 320 is directly connected to the camshaft and only the outer sprocket 310 is freely rotated and assembled, a timing error according to positions may be reduced to approximately 0.3 degrees, which is significantly smaller than the approximately 3 degrees of the related art, and since the tensioner 20 is fixed in a state in which tension is applied to the timing belt 10 using the crank jig 120, the high pressure pump jig 220, and the cam sprocket 300, whereby even though the tensioner 20 is rotated numerous times, timing error due to tension loss is minimized.

In this manner, a sprocket structure of an engine according to one form of the present disclosure includes the crank sprocket 100 provided in a cylinder block of an engine, driven by the crankshaft 110, and having the crank jig 120 inserted into the center thereof to fix the crankshaft 110 and allowing only an outer portion to be rotated, the high pressure pump sprocket 200 receiving rotational force from the crank sprocket 100 through the timing belt 10 and having the high pressure pump jig 220 inserted into the center thereof to fix the shaft 210 of a high pressure pump and allow only an outer portion to be rotated; and the cam sprocket 300 including the outer sprocket 310 formed on an outer side and freely rotated by the timing belt 10 and the inner sprocket 320 provided on an inner side of the outer sprocket 310 and directly connected to a camshaft to fix timing, and applying tension to the timing belt 10. Accordingly, in a state in which tension is applied to the timing belt 10 through the jigs of the crank sprocket 100 and the high pressure pump sprocket 200 and the cam sprocket 300 having a dual-structure, the tensioner 20 is fixed to reduce loss of tension, minimizing the occurrence of an error of the timing belt 10 to enhance quality of a product.

As described above, according to one form of the present disclosure, since the tensioner is fixed in a state in which tension is applied to the timing belt through the jigs of the crank sprocket and the high pressure pump sprocket and the cam sprocket having a dual-structure, loss of tension is reduced, thus minimizing the occurrence of an error of the timing belt to enhance quality of a product.

Hereinabove, although the present disclosure has been described with reference to various forms and the accompanying drawings, the present disclosure is not limited thereto, but may be modified and altered by those skilled in the art to which the present disclosure pertains without departing from the spirit and scope of the present disclosure.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A sprocket structure of an engine, the sprocket structure comprising:
a crank sprocket provided in a cylinder block of the engine and driven by a crank shaft;
a high pressure pump sprocket configured to receive rotational force from the crank sprocket through a timing belt; and
a cam sprocket having an inner sprocket installed on a camshaft and an outer sprocket rotatably coupled to the timing belt so as to be driven.

2. The sprocket structure according to claim 1, wherein the cam sprocket includes:
the outer sprocket formed on an outer side of the cam sprocket and provided to be freely rotated by the timing belt; and
the inner sprocket provided on an inner side of the outer sprocket and directly connected to the camshaft to fix timing,
wherein the cam sprocket applies tension to the timing belt.

3. The sprocket structure according to claim 1, wherein the crank sprocket includes a crank jig inserted into the center thereof to fix a position of the crank sprocket with respect to the crank shaft and to rotate the crank sprocket.

4. The sprocket structure according to claim 1, wherein the high pressure pump sprocket includes a high pressure pump jig inserted into the center thereof to fix a position of the high pressure pump sprocket with respect to a shaft of a high pressure pump configured to rotate the high pressure pump sprocket.

5. The sprocket structure according to claim 2, wherein the inner sprocket is fastened to the outer sprocket by a bolt.

6. The sprocket structure according to claim 5, wherein a plurality of fastening portions are formed on an inner circumferential surface of the outer sprocket to which the inner sprocket is fastened and fixed by the bolt.

7. The sprocket structure according to claim 2, wherein a coupling hole is formed at a center of the inner sprocket to which the camshaft is fixed and coupled.

8. The sprocket structure according to claim 1, wherein a plurality of tensioners fixing tension are provided on an outer side of the timing belt.

9. A sprocket structure of an engine, the sprocket structure comprising:
a crank sprocket provided in a cylinder block of the engine, driven by a crankshaft, the crank sprocket having a crank jig inserted into a center thereof to fix the crankshaft and to allow only an outer portion of the crank sprocket to be rotated;
a high pressure pump sprocket configured to receive rotational force from the crank sprocket through a timing belt, the high pressure pump sprocket having a high pressure pump jig inserted into a center thereof to fix a shaft of a high pressure pump to allow only an outer portion of the high pressure pump sprocket to be rotated; and
a cam sprocket having an outer sprocket formed on an outer side of the cam sprocket and that is freely rotated by the timing belt and an inner sprocket provided within the outer sprocket and directly connected to a camshaft to fix timing and to apply tension to the timing belt.

10. The sprocket structure according to claim 9, wherein a plurality of fastening portions are formed on an inner circumferential surface of the outer sprocket to which the inner sprocket is fastened and fixed by a bolt, and wherein a coupling hole is formed at a center of the inner sprocket to which the camshaft is fixed and coupled.
